(19) United States
(12) Patent Application Publication
(10) Pub. No.: US 2026/0202855 A1
(43) Pub. Date: Jul. 16, 2026

(54) METHOD AND RELATED DEVICE FOR TWO-DIMENSIONAL COMPLETE COVERAGE PATH PLANNING OF MOBILE ROBOT

(71) Applicant: Chengdu University of Technology, Chengdu (CN)

(72) Inventors: Zhijun Li, Chengdu (CN); Pirong Li, Chengdu (CN); Mingjie Tao, Chengdu (CN); Jian Wang, Chengdu (CN)

(21) Appl. No.: 19/450,677

(22) Filed: Jan. 15, 2026

(30) Foreign Application Priority Data
Jan. 16, 2025 (CN) 202510069828.0

(51) Int. Cl. G05D 1/644; G05D 1/246; G05D 1/622; G05D 109/10

(52) U.S. Cl. CPC G05D 1/644; G05D 1/246; G05D 1/622; G05D 2109/10

(57) ABSTRACT

A method for two-dimensional (2D) complete coverage path planning (CCPP) of a mobile robot includes: partitioning a map containing irregular obstacles and concave-convex polygonal obstacles into a plurality of sub-regions using Maklink lines generated based on Maklink graph theory, to simplify a path search problem and improve search efficiency; determining an optimal sub-region visitation sequence and generating an inter-sub-region transition path for the robot; and performing back-and-forth traversal by sequentially executing a Boustrophedon coverage path within each sub-region, which ensures efficient coverage of each entire sub-region and minimizes omissions and repeated coverage. Repetitive paths and ineffective movements are reduced by ensuring that the robot moves between sub-regions in an order guided by the optimal sub-region visitation sequence and the optimal inter-sub-region transition path.

### CROSS-REFERENCE TO RELATED APPLICATION

This application claims priority of Chinese Patent Application No. 202510069828.0, filed on Jan. 16, 2025, the entire contents of which are incorporated herein by reference.

### TECHNICAL FIELD

The present disclosure relates to the technical field of robotic complete coverage path planning (CCPP), and more particularly, to a method and related device for two-dimensional (2D) CCPP of a mobile robot.

### BACKGROUND

In recent years, research on artificial intelligence (AI) algorithms and application technologies has been burgeoning. As one of the representative embodiments of AI technology, mobile robots have emerged as a pivotal frontier eagerly explored by the global scientific community. This trend has led to the increasing deployment of mobile robots across various scenarios, particularly in indoor household services. The application not only assists in or independently completes specific tasks but also significantly facilitates domestic activities, as exemplified by floor-cleaning robots. However, such robots lack reliable global navigation satellite system (GNSS) signals for indoor navigation and also confront the formidable challenges posed by dynamic and complex real-world environments. Consequently, the development of efficient, rational, and accurate path planning algorithms has become a matter of paramount importance in mobile robotics research.

Mobile robot path planning primarily involves two models. The first is the point-to-point optimal path planning model, where the robot autonomously designs a path from a start point to an end point, optimizing for the shortest distance, minimal time, and safe, collision-free travel. The second is the CCPP model, where the robot autonomously designs a path to cover a 2D space, optimizing for the shortest repeated path, highest efficiency, and effective obstacle avoidance. Substantial research has been conducted globally on mobile robot path planning, resulting in the proposal or refinement of numerous algorithms. These range from traditional methods such as the A* algorithm, Dijkstra's algorithm, rapidly-exploring random tree (RRT), probabilistic roadmap method (PRM), and artificial potential field (APF), to intelligent optimization algorithms including genetic algorithm (GA), artificial fish swarm (AFS), particle swarm optimization (PSO), neural networks (NN), and ant colony optimization (ACO). Among these algorithms, ACO, as a heuristic search algorithm, offers notable advantages including strong robustness, excellent distributed computing capability, and ease of integration with other methods. These merits have established ACO as a focal point of research in distributed artificial intelligence. Consequently, many algorithms derived from the ant colony model are being increasingly applied across diverse fields, finding particularly extensive application and development in mobile robot path planning.

However, in mobile robot path planning, a key issue is that the lack of an optimal sub-region visitation sequence leads to significant path repetition in complete coverage tasks. Furthermore, the prevalent use of grid-based maps results in computationally intensive processes and inefficient paths with considerable overlap.

### SUMMARY

To address the problems of path redundancy caused by unoptimized sub-region visitation sequences and the computational burdens of grid-map-based planning, the present disclosure provides a method and related device for 2D CCPP of a mobile robot.

To realize the above objective, the present disclosure provides the following technical solution:
a method for 2D CCPP of a mobile robot includes the steps of:
partitioning a map containing obstacles into a plurality of traversable sub-regions to construct a 2D free space for path planning using Maklink lines generated based on Maklink graph theory;
determining an optimal sub-region visitation sequence using a one-dimensional (1D) ACO algorithm, and generating an optimal inter-sub-region transition path within the 2D free space using a 2D ACO algorithm that minimizes a function value; and
performing back-and-forth traversal by sequentially executing a Boustrophedon coverage path within each sub-region in an order guided by the optimal sub-region visitation sequence and the optimal inter-sub-region transition path.

Preferably, the partitioning a map containing obstacles into a plurality of sub-regions to construct a 2D free space for path planning using Maklink lines generated based on Maklink graph theory includes the steps of:
modeling obstacles within an experimental environment space as concave-convex polygons; connecting vertices of different obstacles using Maklink lines, where each Maklink line does not intersect any obstacle, forms an external angle no greater than 180° with obstacle boundaries, and does not intersect other Maklink lines; and partitioning a workspace into a plurality of convex polygons to construct traversable sub-regions for the mobile robot using the generated Maklink lines, the obstacle boundaries, and boundaries of the 2D map.

Preferably, the determining an optimal sub-region visitation sequence using a 1D ACO algorithm includes the steps of:
identifying adjacent sub-regions that share a common edge; assigning a connection weight of 1 to each pair of such adjacent sub-regions; treating each sub-region as a node to generate a corresponding adjacency matrix; determining a distance between any two sub-regions based on the adjacency matrix; and obtaining a visitation order for the robot by applying a 1D ACO algorithm to solve a traveling salesman problem (TSP).

Preferably, the generating an optimal inter-sub-region transition path within the 2D free space using a 2D ACO algorithm that minimizes a function value includes the steps of:
defining an objective function as a path length from a start point to an end point passing through selected points on specific Maklink lines, with coordinates of these points as independent variables; normalizing the involved Maklink lines; computing corresponding actual point positions on the Maklink lines through denormalization using normalized results for each computational iteration; and obtaining an optimal inter-sub-region transition path for the mobile robot through multiple such iterations.

Preferably, a specific process of performing a secondary optimization on the obtained optimal inter-sub-region transition path via triangle pruning includes the steps of: replacing polyline segments between Vᵢ and Vₖ with a straight line segment between Vᵢ and Vₖ if multiple consecutive nodes Vᵢ, . . . , Vⱼ, . . . , Vₖ in a path form a polyline and a direct connection between Vᵢ and Vₖ is obstacle-free.

Preferably, the performing back-and-forth traversal by sequentially executing a Boustrophedon coverage path within each sub-region in an order guided by the optimal sub-region visitation sequence and the optimal inter-sub-region transition path includes the steps of:
moving the mobile robot to a sub-region to be traversed according to the optimal sub-region visitation sequence and the optimal inter-sub-region transition path; and performing a back-and-forth reciprocating motion along a longest edge of the sub-region to be traversed until reaching an opposite vertex of the edge, at which point the mobile robot continues the reciprocating motion along the same longest edge to achieve CCPP.

A system for 2D CCPP of a mobile robot includes:
a partitioning and construction module, configured to partition a map containing obstacles into a plurality of traversable sub-regions to construct a free space for 2D path planning using Maklink lines generated based on Maklink graph theory;
a computation module, configured to determine an optimal sub-region visitation sequence using a 1D ACO algorithm, and to generate an optimal inter-sub-region transition path within the 2D free space using a 2D ACO algorithm that minimizes a function value; and
a traversal module, configured to perform back-and-forth traversal by sequentially executing a Boustrophedon coverage path within each sub-region in an order guided by the optimal sub-region visitation sequence and the optimal inter-sub-region transition path.

Preferably, in the computation module, a specific process for generating an optimal inter-sub-region transition path within the 2D free space using a 2D ACO algorithm that minimizes a function value includes the steps of:
defining an objective function as a path length from a start point to an end point passing through selected points on specific Maklink lines, with coordinates of these points as independent variables; normalizing the involved Maklink lines; computing corresponding actual point positions on the Maklink lines through denormalization using normalized results for each computational iteration; obtaining an optimal inter-region path for the mobile robot through multiple such iterations; and performing a secondary optimization on the obtained optimal inter-region path via triangle pruning, where if multiple consecutive nodes Vᵢ, . . . , Vⱼ, . . . , Vₖ in a path form a polyline and a direct connection between Vᵢ and Vₖ is obstacle-free, polyline segments between Vᵢ and Vₖ are capable of being replaced with a straight line segment between Vᵢ and Vₖ.

A computer device includes a memory, a processor, and a computer program stored in the memory and running on the processor, which, when executing the computer program, implements the steps of the method for 2D CCPP of a mobile robot.

A computer-readable storage medium includes a computer program stored thereon, which, when loaded by a processor, is capable of executing the steps of the method for 2D CCPP of a mobile robot.

Compared with the related art, the present disclosure has the following beneficial effects. The present disclosure provides a method for 2D CCPP of a mobile robot. In a complex two-dimensional environmental model, such as a map containing irregular obstacles and concave-convex polygonal obstacles, the method includes the steps of: partitioning the map containing irregular obstacles and concave-convex polygonal obstacles into a plurality of sub-regions using Maklink lines generated based on Maklink graph theory, thereby simplifying a path search problem and improving search efficiency; determining an optimal sub-region visitation sequence and generating an inter-sub-region transition path for the robot; and performing back-and-forth traversal by sequentially executing a Boustrophedon coverage path within each sub-region, which ensures efficient coverage of each entire sub-region and minimizes omissions and repeated coverage. Repetitive paths and ineffective movements are reduced by ensuring that the robot moves between sub-regions in an order guided by the optimal sub-region visitation sequence and the optimal inter-sub-region transition path.

Furthermore, the inter-sub-region transition path is further optimized via triangle pruning, refining the sub-optimal path obtained by the ACO algorithm into the optimal path.

### BRIEF DESCRIPTION OF THE DRAWINGS

FIG. 1 is a flowchart of a method for 2D CCPP of a mobile robot according to the present disclosure.

FIG. 2 is a diagram showing partitioning of a planar area using Maklink graph theory according to an embodiment of the present disclosure.

FIG. 3 is a diagram showing an original sub-region visitation sequence after partitioning using Maklink graph theory according to an embodiment of the present disclosure.

FIG. 4 is a diagram showing an optimal sub-region visitation sequence according to an embodiment of the present disclosure.

FIG. 5 is a diagram showing a traversal path of the mobile robot within a first sub-region according to an embodiment of the present disclosure.

FIG. 6 is a diagram showing a simple transition path of the mobile robot from the first sub-region to a second sub-region according to an embodiment of the present disclosure.

FIG. 7 is a diagram showing a complex transition path of the mobile robot from a third sub-region to a fourth sub-region according to an embodiment of the present disclosure.

FIG. 8 is a diagram showing a global traversal path of the mobile robot in a 2D map containing concave-convex polygonal obstacles according to an embodiment of the present disclosure.

FIG. 9 is a schematic diagram showing triangle pruning (geometric optimization) according to an embodiment of the present disclosure.

FIG. 10 is a block diagram of a system for 2D CCPP of a mobile robot according to the present disclosure.

### DETAILED DESCRIPTION

For clarity of the objectives, technical solutions, and advantages of the embodiments of the present disclosure, the technical solutions in the embodiments of the present disclosure are further described clearly and completely below with reference to the accompanying drawings. Obviously, the embodiments described are only some, rather than all embodiments of the present disclosure. Components of the embodiments depicted and described in the accompanying drawings herein may be arranged and designed in multiple configurations.

Therefore, the detailed description of the embodiments of the present disclosure provided in the accompanying drawings is not intended to limit the scope of the claimed disclosure, but is merely representative of selected embodiments of the present disclosure. Based on the embodiments of the present disclosure, all other embodiments obtained by those ordinary skilled in the art without creative efforts fall within the scope of protection of the present disclosure.

It is to be noted that similar reference numbers and letters in the accompanying drawings denote similar items. Accordingly, once an item is defined with reference to one drawing, it may not be discussed again for subsequent drawings.

To facilitate a better understanding of the technical solutions of the present disclosure by those skilled in the art, the present disclosure is further described in detail below with reference to the accompanying drawings.

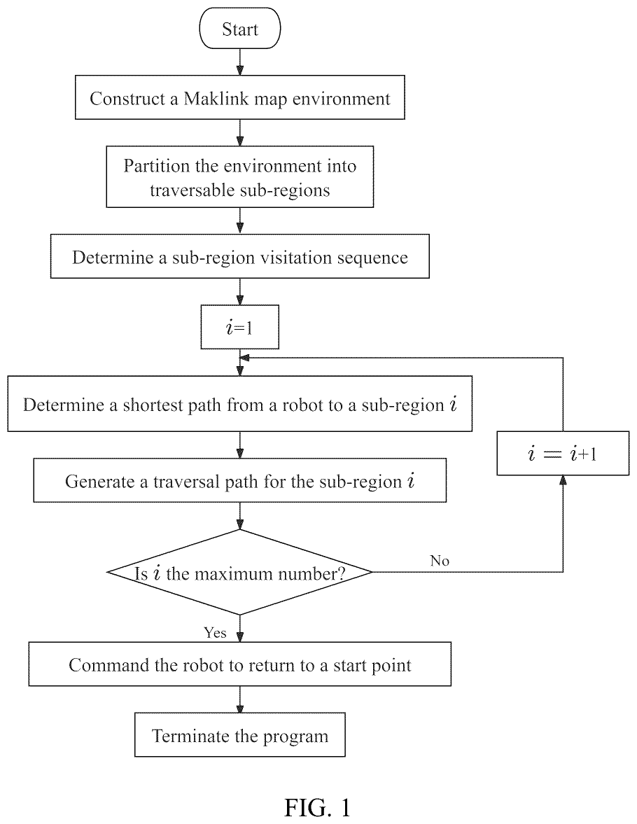

As shown in FIG. 1, the present disclosure provides a method for 2D CCPP of a mobile robot, including the following steps:
a map containing obstacles is partitioned into a plurality of traversable sub-regions to construct a free space for 2D path planning using Maklink lines generated based on Maklink graph theory;
an optimal sub-region visitation sequence is determined using a 1D ACO algorithm, and an optimal inter-sub-region transition path is generated for the robot within the 2D free space using a 2D ACO algorithm that minimizes a function value; and

Back-and-forth traversal is performed by sequentially executing a Boustrophedon coverage path within each sub-region in an order guided by the optimal sub-region visitation sequence and the optimal inter-sub-region transition path.

The detailed steps are as follows:
the method employs Maklink graphs based on the free space approach to establish an environmental model.

The free space approach represents obstacles by vertices thereof, and the experimental environment space is subject to the following assumptions: there exist m obstacles in the environment space; an ith obstacle Oᵢ possesses nᵢ (nᵢ≥3) vertices. Thus, the obstacles and the environment are expressed as:

$$\begin{matrix}{O}_{i} = \{ ( {x}_{i 1} , {y}_{i 1} ) , ( {x}_{i 2} , {y}_{i 2} ) , … , ( {x}_{i {n}_{i}} , {y}_{i {n}_{i}} ) \} \\ W = \{ {O}_{1} , {O}_{2} , … , {O}_{m} \}\end{matrix}$$

where (xᵢⱼ, yᵢⱼ), i=1, 2, . . . , m, j=1, 2, . . . , n, and n denotes coordinates of an ith vertex of the ith obstacle.

Subsequently, the Maklink graph is constructed by applying the principles and basic requirements of free linking lines in Maklink graph theory, through the following steps:

in step I, a set is formed by combining all the vertices of the concave-convex polygonal obstacles:

$${O}_{i} = \{ ( {x}_{11} , {y}_{11} ) , ( {x}_{12} , {y}_{12} ) , … , ( {x}_{ij} , {y}_{i j} ) , … , ( {x}_{m {n}_{m}} , {y}_{m {n}_{m}} ) \}$$

Perpendiculars are drawn from vertices to boundaries, all points are connected pairwise, and the resulting segments are sorted from shortest to longest and stored in a set L.

In step II, the first line segment is selected from the set L.

In step III, it is determined whether the selected segment intersects with any concave-convex polygonal obstacle. If intersected, the segment is discarded as a Maklink line, and the next segment in the set L is examined. This examination is repeated until a segment is found that does not intersect any obstacle, after which the process proceeds to step IV.

In step IV, the two external angles formed by this segment with the obstacle vertices are checked. If the two external angles are ≤180°, the segment is designated as an optimal connection line. Other connection lines for this vertex are deleted, and the process proceeds to step VII. If any external angle is >180°, the connection line is added to candidate connection lines for this vertex.

In step V, all candidate lines for this vertex are checked for the existence of any external angle>180°. If such a candidate exists, the next segment is selected from the set L, and the process returns to step III. If none exists, the process proceeds to step VI.

In step VI, other redundant connection lines for this vertex are deleted.

In step VII, steps I-VI are repeated until all vertices are processed, thereby completing the construction of the Maklink graph.

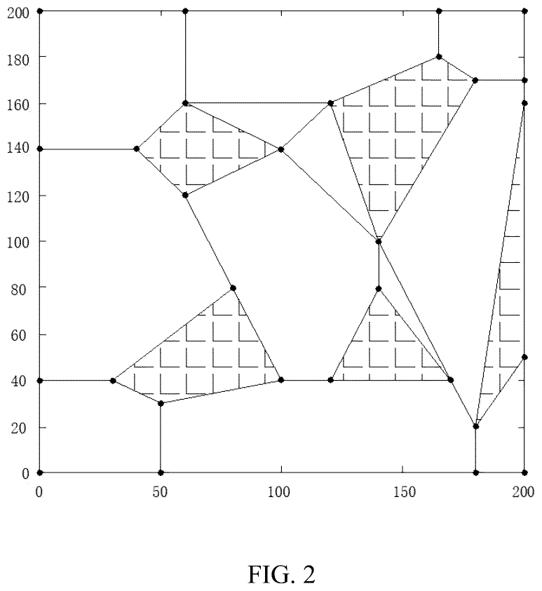

Furthermore, the principle for partitioning sub-regions in the method is as follows:
on the Maklink map, the convex polygons enclosed by Maklink lines, obstacle boundaries, and 2D map boundaries are the traversable sub-regions for the mobile robot, as shown in FIG. 2.

A 1D ACO algorithm is employed to derive the sequence in which the mobile robot visits the sub-regions (a generalized Hamiltonian path) and to assign identifiers to the sub-regions.

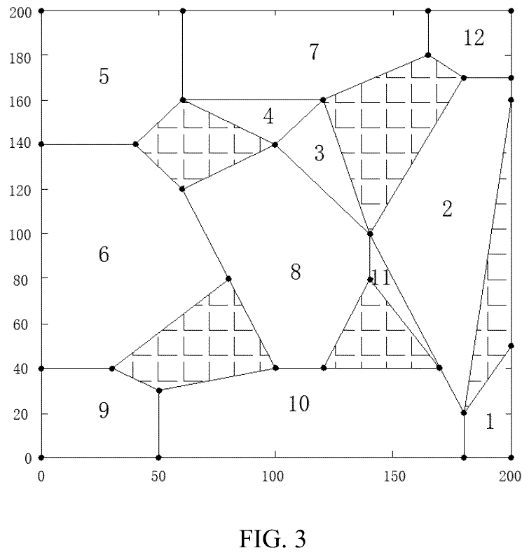

In the original visitation sequence graph (as shown in FIG. 3), when two sub-regions share a common edge, the two sub-regions are considered connected, and a connection weight of 1 is assigned. Each sub-region is treated as a node, yielding the corresponding adjacency matrix:

$$A = [ \begin{matrix}0 & 0 & 0 & 0 & 0 & 0 & 0 & 0 & 0 & 1 & 0 & 0 \\ 0 & 0 & 0 & 0 & 0 & 0 & 0 & 0 & 0 & 1 & 1 & 1 \\ 0 & 0 & 0 & 1 & 0 & 0 & 0 & 1 & 0 & 0 & 0 & 0 \\ 0 & 0 & 1 & 0 & 0 & 0 & 1 & 0 & 0 & 0 & 0 & 0 \\ 0 & 0 & 0 & 0 & 0 & 1 & 1 & 0 & 0 & 0 & 0 & 0 \\ 0 & 0 & 0 & 0 & 1 & 0 & 0 & 1 & 1 & 0 & 0 & 0 \\ 0 & 0 & 0 & 1 & 1 & 0 & 0 & 0 & 0 & 0 & 0 & 1 \\ 0 & 0 & 1 & 0 & 0 & 1 & 0 & 0 & 0 & 1 & 1 & 0 \\ 0 & 0 & 0 & 0 & 0 & 1 & 0 & 0 & 0 & 1 & 0 & 0 \\ 1 & 1 & 0 & 0 & 0 & 0 & 0 & 1 & 1 & 0 & 0 & 0 \\ 0 & 1 & 0 & 0 & 0 & 0 & 0 & 1 & 0 & 0 & 0 & 0 \\ 0 & 1 & 0 & 0 & 0 & 0 & 1 & 0 & 0 & 0 & 0 & 0\end{matrix} ]$$

Based on the adjacency matrix A, the path length between any two sub-regions is given by the weight matrix:

$$W = [ \begin{matrix}0 & 2 & 3 & 4 & 4 & 3 & 4 & 2 & 2 & 1 & 3 & 3 \\ 2 & 0 & 3 & 3 & 3 & 3 & 2 & 2 & 2 & 1 & 1 & 1 \\ 3 & 3 & 0 & 1 & 3 & 2 & 2 & 1 & 3 & 2 & 2 & 3 \\ 4 & 3 & 1 & 0 & 2 & 3 & 1 & 2 & 4 & 3 & 3 & 2 \\ 4 & 3 & 3 & 2 & 0 & 1 & 1 & 2 & 2 & 3 & 3 & 2 \\ 3 & 3 & 2 & 3 & 1 & 0 & 2 & 1 & 1 & 2 & 2 & 3 \\ 4 & 2 & 2 & 1 & 1 & 2 & 0 & 3 & 3 & 3 & 3 & 1 \\ 2 & 2 & 1 & 2 & 2 & 1 & 3 & 0 & 2 & 1 & 1 & 3 \\ 2 & 2 & 3 & 4 & 2 & 1 & 3 & 2 & 0 & 1 & 3 & 3 \\ 1 & 1 & 2 & 3 & 3 & 2 & 3 & 1 & 1 & 0 & 2 & 2 \\ 3 & 1 & 2 & 3 & 3 & 2 & 3 & 1 & 3 & 2 & 0 & 2 \\ 3 & 1 & 3 & 2 & 2 & 3 & 1 & 3 & 3 & 2 & 2 & 0\end{matrix} ]$$

The specific 1D ACO algorithm is described as follows:

Let the total number of ants in the ant colony be m, the number of sub-regions be n, and the distance between a sub-region i and a sub-region j be dᵢⱼ (i, j=1,2, . . . , n). The pheromone concentration on the path connecting the sub-region i and the sub-region j at time t is denoted as τᵢⱼ(t). At the initial moment, the pheromone concentrations on the connecting paths between all sub-regions are set to be equal, which may be denoted as τᵢⱼ(t)=τ₀.

Ant k(k=1, 2, . . . , n) determines the next sub-region to visit based on the pheromone concentrations on the paths between sub-regions. Let

$${P}_{i j}^{k} ( t )$$

denotes the probability that the ant k transfers from the sub-region i to the sub-region j at time t, calculated by the formula:

$${P}_{ij}^{k} = \{ \begin{matrix}\frac{{[ {τ}_{ij} ( t ) ]}^{α} \cdot {[ {η}_{ij} ( t ) ]}^{β}}{{{\sum }_{s ∈ {allow}_{k}} [ {τ}_{is} ( t ) ]}^{α} \cdot {[ {η}_{is} ( t ) ]}^{β}} , s ∈ {allow}_{k} \\ 0 , s ∉ {allow}_{k}\end{matrix}$$

where ηᵢⱼ(t) is a heuristic function, defined as ηᵢⱼ(t)=1/dᵢⱼ, representing the desirability for an ant to move from the sub-region i to the sub-region j. allowₖ(k=1, 2, . . . , m) is a set of sub-regions remaining to be visited by the ant k. Initially, allowₖ contains (n−1) elements, i.e., all sub-regions except the starting sub-region of the ant k. As time progresses, the elements in allowₖ continuously decrease until the set becomes empty, indicating that all sub-regions have been visited.

α is a pheromone importance factor. A larger value indicates that pheromone concentration plays a greater role in the transition. β is the heuristic function importance factor. A larger value indicates that the heuristic function plays a greater role in the transition, meaning the ant will have a higher probability of moving to a closer sub-region.

The ACO algorithm relies on pheromones to guide the search of ants. The method for setting and updating pheromone concentrations is crucial for the algorithm's successful search, with the pheromone at each point being updated after an ant passes through it.

Pheromone update includes two parts: local update and global update. Local update refers to the reduction of pheromone at a point immediately after an ant traverses it. The purpose of local updating is to increase the probability of ants exploring unvisited points, thereby promoting global search. Local pheromone updating occurs during the ant's search, and the update formula is:

$${τ}_{i j} = ( 1 - ζ ) {τ}_{i j}$$

where τᵢⱼ is the pheromone value on the path connecting the sub-region i and the sub-region j; and ζ is a pheromone decay coefficient.

While ants deposit pheromones, the pheromone concentration on the paths between sub-regions gradually diminishes. Let the parameter ρ(0<ρ<1) represents the volatility rate of the pheromone. Therefore, after all ants complete one cycle, the pheromone concentration on each path between sub-regions needs to be updated in real time, as follows:

$$\{ \begin{matrix}{τ}_{i j} ( t + 1 ) = ( 1 - ρ ) {τ}_{i j} ( t ) + Δ {τ}_{i j} \\ Δ {τ}_{i j} = {\sum }_{k = 1}^{n} Δ {τ}_{i j}^{k}\end{matrix} , 0 < ρ < 1$$

where

$${Δτ}_{i j}^{k}$$

denotes the pheromone concentration deposited by a kth ant on the path connecting the sub-region i and the sub-region j; and Δτᵢⱼ denotes the total pheromone concentration deposited by all ants on the path connecting the sub-region i and the sub-region j.

Ants traversing shorter paths deposit a greater amount of pheromone. Over time, the pheromone concentration accumulates progressively on these shorter paths, attracting an increasing number of ants to select the shorter paths. Ultimately, through positive feedback, the entire colony converges on the optimal path, which corresponds to the optimal solution of the optimization problem.

Subsequently, an optimal inter-sub-region transition path is generated for the robot within the 2D free space using a 2D ACO algorithm that minimizes a function value:

$$\begin{matrix}P = \{ {p}_{1} , {p}_{2} , … , {p}_{k} \} \\ {p}_{i} = \{ S , {V}_{1} , {V}_{2} , … {V}_{d} , T \}\end{matrix}$$

where V₁, V₂, . . . . V_{d} denote nodes through which the path passes in sequence, Lᵢ(i=1, 2, . . . , d) denotes a corresponding free link line, and S and T denote a start point and an end point, respectively;

Let

$${V}_{i}^{( 0 )} and {V}_{i}^{( 1 )}$$

be two endpoints of Lᵢ. Within the free space corresponding to one side of an obstacle, other points on the link line can be expressed as:

$${V}_{i} ( {h}_{i} ) = {V}_{i}^{( 0 )} + ( 1 - {h}_{i} ) {V}_{i}^{( 1 )}$$

where hᵢ is a scaling parameter with hᵢ ∈[0,1], i=1, 2, . . . , d; a set (h₁, h₂, . . . , h_{d}) corresponds to a path; and (h₁, h₂, . . . , h_{d}) is an optimized solution obtained by the ACO algorithm that minimizes a function value.

Function value minimization serves as a methodology for determining the shortest path between two points. A principle of the algorithm that minimizes a function value is illustrated below using a three-segment path as a concrete example.

Let start point coordinates be (xₛ, yₛ) and end point coordinates be (xₜ, yₜ). For the first segment of the three-segment path, its start and end points are (x₁₀, y₁₀) and (x₁ₑ, y₁ₑ). This segment can be represented by a vector V̅=(a₁, b₁), where a₁=x₁ₑ−x₁₀ and b₁=y₁ₑ−y₁₀. Consequently, any point on this segment is given by: (x₁, y₁)=(x₁₀, y₁₀)+t₁ (a₁, b₁), t₁ ∈[0,1].

For the second segment, its start and end points are (x₂₀, y₂₀) and (x₂ₑ, y₂ₑ), and for the third segment, its start and end points are (x₃₀, y₃₀) and (x₃ₑ, y₃ₑ). The same principle is applied to obtain:

$$\begin{matrix}{a}_{2} = {x}_{2 e} - {x}_{20} , {b}_{2} = {y}_{2 e} - {y}_{20} and {a}_{3} = {x}_{3 e} - {x}_{30} , {b}_{3} = {y}_{3 e} - {y}_{30} \\ ( {x}_{2} , {y}_{2} ) = ( {x}_{20} , {y}_{20} ) + {t}_{2} ( {a}_{2} , {b}_{2} ) , {t}_{2} ∈ [ 0 , 1 ] \\ ( {x}_{3} , {y}_{3} ) = ( {x}_{30} , {y}_{30} ) + {t}_{3} ( {a}_{3} , {b}_{3} ) , {t}_{3} ∈ [ 0 , 1 ]\end{matrix}$$

An expression for a path length from the start point to the end point is given by:

$$f ( {t}_{1} , {t}_{2} , {t}_{3} ) = \sqrt{{( {x}_{s} - {x}_{1} )}^{2} + {( {y}_{s} - {y}_{1} )}^{2}} + \sqrt{{( {x}_{1} - {x}_{2} )}^{2} + {( {y}_{1} - {y}_{2} )}^{2}} + \sqrt{{( {x}_{3} - {x}_{t} )}^{2} + {( {y}_{3} - {y}_{t} )}^{2}}$$

The ACO algorithm is applied to iteratively solve the above path length expression to find the optimal value. The optimal value includes a minimum function value obtained in each iteration and corresponding values of independent variables obtained.

For each iteration, solutions for t₁, t₂, t₃ and corresponding path length values fᵢ are obtained. Let a maximum value from the path length values be fₘₐₓ and a minimum value be fₘᵢₙ. The pheromone is defined as:

$${f}_{max} - {f}_{i} = T a {u}_{i}$$

During iteration using the ACO algorithm, an expression for a heuristic function is given by:

$$T M T = T a u - min ( Tau )$$

Consequently, an expression for an ant's state transition probability is given by:

$$\begin{matrix}{P}_{O} = T a {u}^{alpha} \times T m {T}^{b e t a} \\ PT = {P}_{O} / sum ( {P}_{O} )\end{matrix}$$

The probability value for local search and global search is the median value P_{O} of PT. A smaller function value corresponds to a greater transition probability such that a local search is favored, and a larger function value corresponds to a smaller transition probability such that a global search is favored;

During iterative optimization with the colony of ants, if a state transition probability value is greater than P_{O}, a local search is performed by the colony of ants, where a search range for t is confined to

$$\pm \frac{1}{T} ,$$

and T denotes a number of iterations. If the state transition probability value is less than P_{O}, a global search is performed by the colony of ants, where the search range for t is set to [0,1]. The search is continued until values for t₁, t₂, t₃ are obtained that minimize the path length f (t₁, t₂, t₃).

During an iterative solving process, if tᵢ<0 (i=1,2,3), let a value be tᵢ=0. If tᵢ>1 (i=1,2,3), let a value be tᵢ=1. The values are substituted in a next iterative computation. Iterative computations are repeated until either a predefined maximum number of iterations is reached or an optimal value remains unchanged over a predefined number of consecutive generations, thereby obtaining a minimum function value as determined by the ACO algorithm.

In summary, the ACO algorithm that minimizes a function value takes the path length from the start point to the end point via selected points on Maklink lines as the objective function, with the coordinates of these points serving as the independent variables. To facilitate the solution process, the involved Maklink lines are normalized. In each computation, the actual positions on these Maklink lines are derived through denormalization based on the normalized results. Through multiple iterations, the optimal inter-region transition path for the mobile robot is obtained.

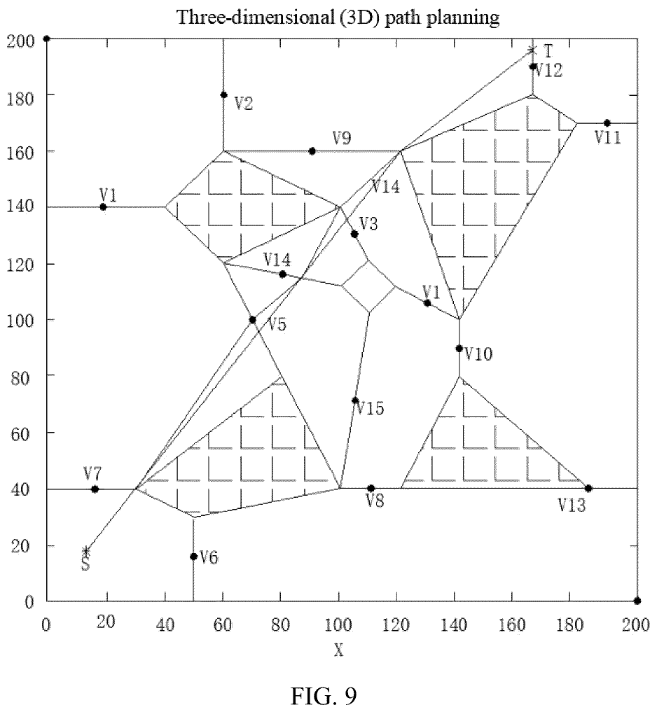

The fundamental principle of triangle pruning (geometric optimization) is that if multiple consecutive nodes Vᵢ, . . . , Vⱼ, . . . , Vₖ in a path form a polyline and a direct connection between Vᵢ and Vₖ is obstacle-free, polyline segments between Vᵢ and Vₖ can be replaced with a straight line segment between Vᵢ and Vₖ, thereby simplifying the path. As shown in FIG. 9, the green line represents the initially planned path, and the red line represents the optimized path after applying triangle pruning.

A Boustrophedon coverage path is employed on the Maklink map to obtain the optimal path traversing all sub-regions.

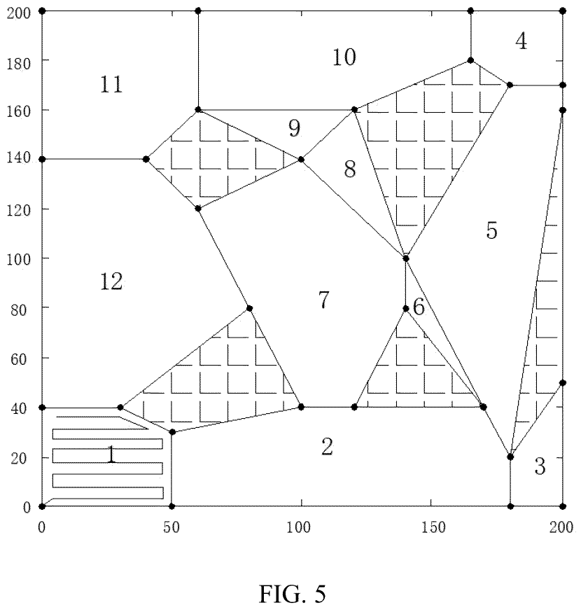

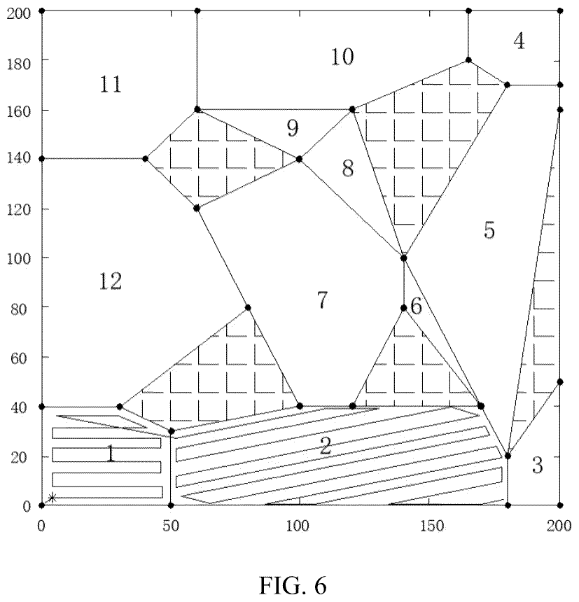

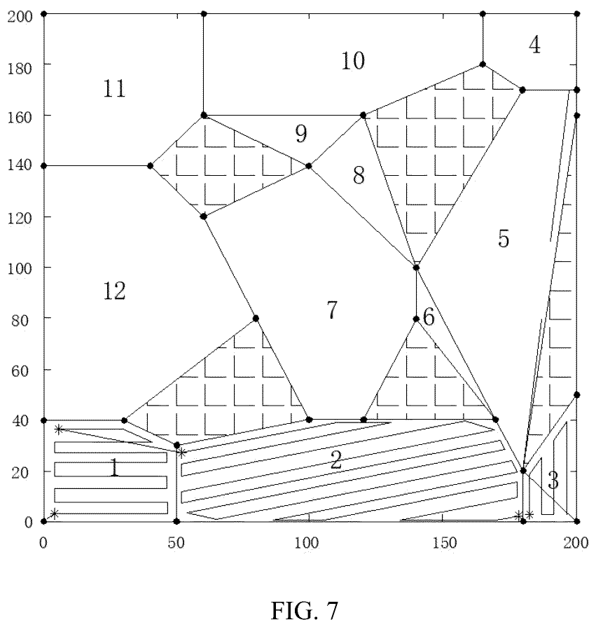

The mobile robot moves along the shortest path to the vicinity of a vertex of a sub-region to be traversed, as indicated by the blue dotted lines in FIGS. 6 and 7. Subsequently, the robot performs a back-and-forth reciprocating motion along a longest edge of the sub-region to be traversed until reaching an opposite vertex of the edge, at which point the mobile robot continues the reciprocating motion along the same longest edge to achieve CCPP, as shown by the red solid lines in FIGS. 5, 6, 7, and 8.

Compared with the related art, the present disclosure has the following beneficial effects.

The present disclosure establishes a model in which the entire 2D planar space is partitioned into a plurality of sub-regions (each being a convex polygon) by free linking lines of a Maklink graph. The Maklink graph algorithm is capable of modeling maps for arbitrarily complex 2D environments, which offers advantages such as low information storage requirements, high decision-making efficiency, and strong robustness.

The connection order of the sub-regions is formulated as a TSP. A one-dimensional ACO algorithm is applied to derive the optimal sub-region visitation sequence. During this process, local pheromone is augmented to increase the diversity of paths explored by ants within a single iteration.

A traversable network space model for the robot is constructed using the free linking lines of the Maklink graph. The ACO algorithm that minimizes a function value is applied to derive the optimal inter-region transition path, thereby increasing the number of possible position selections on each free link line considered for the path.

A Boustrophedon motion path parallel to one edge within the sub-region is planned in real time, completing the global traversal path planning.

Another embodiment of the present disclosure provides a method for 2D CCPP of a mobile robot.

The simulation environment for this path planning experiment is configured as follows: Windows 11 Home Chinese Edition; Matlab R2017b; Processor: 12th Gen Intel® Core™ i5-12500H; Base Frequency: 2.5 GHz; and Memory: 16 GB. A method for 2D CCPP of a mobile robot based on the Maklink graph and the Boustrophedon coverage path:

### I. Modeling of the Mobile Robot's Working Environment

Current common environmental modeling methods for mobile robots include the grid-based method, the Maklink graph approach, and the visibility graph method. Among these, the grid-based method suffers from issues such as large map information volume and low decision-making efficiency in complex environments. Therefore, the embodiment of the present disclosure employs the Maklink graph approach to establish the environmental model.

It is assumed that the mobile robot moves within a static 2D space, where obstacles are represented by concave-convex polygons whose height is perpendicular to the XY plane. The boundaries of the obstacles are expanded according to the robot's maximum dimensions and the minimum range required for its normal perception. The mobile robot itself is simplified as a point mass, and obstacles are represented by the vertices thereof. The experimental environment space is subject to the following assumptions: there exist m obstacles in the environment space; an ith obstacle Oᵢ possesses nᵢ (nᵢ≥3) vertices. Thus, the obstacles and the environment are expressed as:

$$\begin{matrix}{O}_{i} = \{ ( {x}_{i 1} , {y}_{i 1} ) , ( {x}_{i 2} , {y}_{i 2} ) , … , ( {x}_{i {n}_{i}} , {y}_{i {n}_{i}} ) \} \\ W = \{ {O}_{1} , {O}_{2} , … , {O}_{m} \}\end{matrix}$$

where (xᵢⱼ, yᵢⱼ), i=1, 2, . . . , m, j=1, 2, . . . , n, and n denotes coordinates of an ith vertex of the jth obstacle. Subsequently, the Maklink graph is constructed by applying the principles of free linking lines, with reference to the foundational research by Professor Maki K. Habib (1991). In this model, obstacles are represented as concave-convex polygons, and vertices of different obstacles are connected using Maklink lines, where each Maklink line does not intersect any obstacle, forms an external angle no greater than 180° with obstacle boundaries, and does not intersect other Maklink lines. A workspace is partitioned into a plurality of convex polygons to construct traversable sub-regions for the mobile robot using the generated Maklink lines, the obstacle boundaries, and boundaries of the 2D map, as shown in FIG. 2.

### II. Establishment of an ACO Algorithm for Determining a Sub-Region Visitation Sequence

Let the total number of ants in the ant colony be m, the number of sub-regions be n, and the distance between a sub-region i and a sub-region j be dᵢⱼ (i, j=1,2, . . . , n). The pheromone concentration on the path connecting the sub-region i and the sub-region j at time t is denoted as τᵢⱼ(t). At the initial moment, the pheromone concentrations on the connecting paths between all sub-regions are set to be equal, which may be denoted as τᵢⱼ(t)=τ₀.

Ant k (k=1, 2, . . . , n) determines the next sub-region to visit based on the pheromone concentrations on the paths between sub-regions. Let

$${P}_{i j}^{k} ( t )$$

denotes the probability that the ant k transfers from the sub-region i to the sub-region j at time t, calculated by the formula:

$${P}_{ij}^{k} = \{ \begin{matrix}\frac{{[ {τ}_{ij} ( t ) ]}^{α} \cdot {[ {η}_{ij} ( t ) ]}^{β}}{{{\sum }_{s ∈ {allow}_{k}} [ {τ}_{is} ( t ) ]}^{α} \cdot {[ {η}_{is} ( t ) ]}^{β}} , s ∈ {allow}_{k} \\ 0 , s ∉ {allow}_{k}\end{matrix}$$

where ηᵢⱼ(t) is a heuristic function, defined as ηᵢⱼ(t)=1/dᵢⱼ, representing the desirability for an ant to move from the sub-region i to the sub-region j. allowₖ (k=1, 2, . . . , m) is a set of sub-regions remaining to be visited by the ant k. Initially, allowₖ contains (n−1) elements, i.e., all sub-regions except the starting sub-region of the ant k. As time progresses, the elements in allowₖ continuously decrease until the set becomes empty, indicating that all sub-regions have been visited.

α is a pheromone importance factor. A larger value indicates that pheromone concentration plays a greater role in the transition. B is the heuristic function importance factor. A larger value indicates that the heuristic function plays a greater role in the transition, meaning the ant will have a higher probability of moving to a closer sub-region.

Pheromone update includes two parts: local update and global update. Local update refers to the reduction of pheromone at a point immediately after an ant traverses it. The purpose of local updating is to increase the probability of ants exploring unvisited points, thereby promoting global search. Local pheromone updating occurs during the ant's search, and the update formula is:

$${τ}_{i j} = ( 1 - ζ ) {τ}_{i j}$$

where τᵢⱼ is the pheromone value on the path connecting the sub-region i and the sub-region j; and ζ is a pheromone decay coefficient.

While ants deposit pheromones, the pheromone concentration on the paths between sub-regions gradually diminishes. Let the parameter ρ(0<ρ<1) represents the volatility rate of the pheromone. Therefore, after all ants complete one cycle, the pheromone concentration on each path between sub-regions needs to be updated in real time, as follows:

$$\{ \begin{matrix}{τ}_{i j} ( t + 1 ) = ( 1 - ρ ) {τ}_{i j} ( t ) + Δ {τ}_{i j} \\ Δ {τ}_{i j} = {\sum }_{k = 1}^{n} Δ {τ}_{i j}^{k}\end{matrix} , 0 < ρ < 1$$

where

$$Δ {τ}_{i j}^{k}$$

denotes the pheromone concentration deposited by a kth ant on the path connecting the sub-region i and the sub-region j; and Δτᵢⱼ denotes the total pheromone concentration deposited by all ants on the path connecting the sub-region i and the sub-region j.

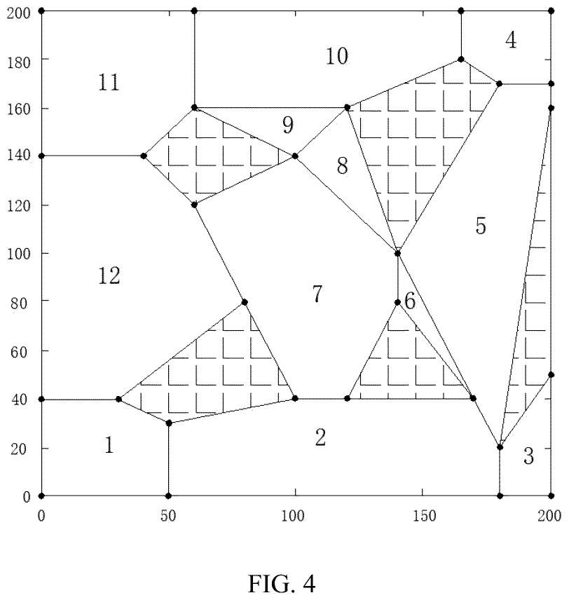

Ants traversing shorter paths deposit a greater amount of pheromone. Over time, the pheromone concentration accumulates progressively on these shorter paths, attracting an increasing number of ants to select the shorter paths. Ultimately, through positive feedback, the entire colony converges on the optimal path, which corresponds to the optimal solution of the optimization problem, thereby obtaining the optimal sub-region visitation sequence, as shown in FIG. 4.

III. Establishment of the ACO Algorithm that Minimizes a Function Value for Determining the Shortest Path

Subsequently, an optimal inter-sub-region transition path is generated for the robot within the 2D free space using a 2D ACO algorithm that minimizes a function value:

$$P = \{ {p}_{1} , {p}_{2} , … , {p}_{k} \}$$

$${p}_{i} = \{ S , {V}_{1} , {V}_{2} , … {V}_{d} , T \}$$

where V₁, V₂, . . . . V_{d} denote nodes through which the path passes in sequence, Lᵢ(i=1, 2, . . . , d) denotes a corresponding free link line, and S and T denote a start point and an end point, respectively.

Let

$${V}_{i}^{( 0 )} and {V}_{i}^{( 1 )}$$

be two endpoints of Lᵢ. Within the free space corresponding to one side of an obstacle, other points on the link line can be expressed as:

$${V}_{i} ( {h}_{i} ) = {V}_{i}^{( 0 )} + ( 1 - {h}_{i} ) {V}_{i}^{( 1 )}$$

where hᵢ is a scaling parameter with hᵢ €[0,1], i=1, 2, . . . , d; a set (h₁, h₂, . . . , h_{d}) corresponds to a path; and (h₁, h₂, . . . , h_{d}) is an optimized solution obtained by the ACO algorithm that minimizes a function value.

Function value minimization serves as a methodology for determining the shortest path between two points. A principle of the algorithm that minimizes a function value is illustrated below using a three-segment path as a concrete example.

Let start point coordinates be (xₛ, yₛ), and end point coordinates be (xₜ, yₜ). For the first segment of the three-segment path, its start and end points are (x₁₀, y₁₀), and (x₁ₑ, y₁ₑ). This segment can be represented by a vector V̅=(a₁, b₁), where a₁=x₁ₑ−x₁₀ and b₁=y₁ₑ−y₁₀. Consequently, any point on this segment is given by: (x₁, y₁)=(x₁₀, y₁₀)+t₁ (a₁, b₁), t₁ ∈[0,1].

For the second segment, its start and end points are (x₂₀, y₂₀) and (x₂ₑ, y₂ₑ), and for the third segment, its start and end points are (x₃₀, y₃₀) and (x₃ₑ, y₃ₑ). The same principle is applied to obtain:

$${a}_{2} = {x}_{2 e} - {x}_{20} , {b}_{2} = {y}_{2 e} - {y}_{20} and {a}_{3} = {x}_{3 e} - {x}_{30} , {b}_{3} = {y}_{3 e} - {y}_{30}$$

$$( {x}_{2} , {y}_{2} ) = ( {x}_{20} , {y}_{20} ) + {t}_{2} ( {a}_{2} , {b}_{2} ) , {t}_{2} ∈ [ 0 , 1 ]$$

$$( {x}_{3} , {y}_{3} ) = ( {x}_{30} , {y}_{30} ) + {t}_{3} ( {a}_{3} , {b}_{3} ) , {t}_{3} ∈ [ 0 , 1 ]$$

An expression for a path length from the start point to the end point is given by:

$$f ( {t}_{1} , {t}_{2} , {t}_{3} ) = \sqrt{{( {x}_{s} - {x}_{1} )}^{2} + {( {y}_{s} - {y}_{1} )}^{2}} + \sqrt{{( {x}_{1} - {x}_{2} )}^{2} + {( {y}_{1} - {y}_{2} )}^{2}} + \sqrt{{( {x}_{3} - {x}_{t} )}^{2} + {( {y}_{3} - {y}_{t} )}^{2}}$$

The ACO algorithm is applied to iteratively solve the above path length expression to find the optimal value. The optimal value includes a minimum function value obtained in each iteration and corresponding values of independent variables obtained.

For each iteration, solutions for t₁, t₂, t₃, and corresponding path length values fᵢ are obtained. Let a maximum value from the path length values be fₘₐₓ and a minimum value be fₘᵢₙ. The pheromone is defined as:

$${f}_{max} - {f}_{i} = {Tau}_{i}$$

During iteration using the ACO algorithm, an expression for a heuristic function is given by:

$$TMT = Tau - min ( Tau )$$

Consequently, an expression for an ant's state transition probability is given by:

$${P}_{O} = {Tau}^{alpha} \times {TmT}^{beta}$$

$$PT = {P}_{O} / sum ( {P}_{O} )$$

The probability value for local search and global search is the median value P_{O} of PT. A smaller function value corresponds to a greater transition probability such that a local search is favored, and a larger function value corresponds to a smaller transition probability such that a global search is favored;

During iterative optimization with the colony of ants, if a state transition probability value is greater than P_{O}, a local search is performed by the colony of ants, where a search range for t is confined to

$$\pm \frac{1}{T} ,$$

and T′ denotes a number of iterations. If the state transition probability value is less than P_{O}, a global search is performed by the colony of ants, where the search range for t is set to [0,1]. The search is continued until values for t₁, t₂, t₃ are obtained that minimize the path length f(t₁, t₂, t₃).

During an iterative solving process, if tᵢ<0 (i=1,2,3), let a value be tᵢ=0. If tᵢ>1 (i=1,2,3), let a value be tᵢ=1. The values are substituted in a next iterative computation. Iterative computations are repeated until either a predefined maximum number of iterations is reached or an optimal value remains unchanged over a predefined number of consecutive generations, thereby obtaining a minimum function value as determined by the ACO algorithm.

The fundamental principle of triangle pruning is that if multiple consecutive nodes Vᵢ, . . . , Vⱼ, . . . , Vₖ in a path form a polyline and a direct connection between Vᵢ and Vₖ is obstacle-free, polyline segments between Vᵢ and Vₖ can be replaced with a straight line segment between Vᵢ and Vₖ, thereby simplifying the path.

### IV. Establishment of a Boustrophedon Path

The mobile robot moves to a sub-region to be traversed along the shortest path. Subsequently, the robot performs a back-and-forth reciprocating motion along a longest edge of the sub-region to be traversed until reaching an opposite vertex of the edge, at which point the mobile robot continues the reciprocating motion along the same longest edge to achieve CCPP.

### V. a Method for 2D CCPP of a Mobile Robot Based on the Maklink Graph and The Boustrophedon Coverage Path

In an embodiment of the present disclosure, the entire 2D planar space is partitioned into a plurality of sub-regions (each being a convex polygon) using the free linking lines of a Maklink graph. The connectivity order of the sub-regions is transformed into a TSP, and a one-dimensional ACO algorithm is applied to determine the sub-region visitation sequence. A traversable network space model for the robot is constructed based on the free linking lines of the Maklink graph, and the ACO algorithm that minimizes a function value is configured to derive the optimal inter-sub-region transition path for the robot. A Boustrophedon motion path parallel to an edge within each sub-region is planned in real time, thereby achieving global coverage path planning. The following provides a detailed analysis of the process in conjunction with an example map.

The map has a horizontal coordinate range of [0, 200] and a vertical coordinate range of [0, 200].

The vertex coordinates of the obstacles are as follows:
first obstacle: [40, 140], [60, 160], [100, 140], and [60, 120];
second obstacle: [50, 30], [30, 40], [80, 80], and [100, 40];
third obstacle: [120, 160], [140, 100], [180, 170], and [165, 180];
fourth obstacle: [120, 40], [170, 40], and [140, 80]; and
fifth obstacle: [180, 20], [220, 80], and [200, 160].

The initial position of the mobile robot is [−0.2, −0.2].

The spacing between two adjacent Boustrophedon paths is 5.

Parameters for the 1D and 2D ACO algorithms are as follows:
number of ants: 50;
maximum number of iterations: 30;
pheromone importance factor: 2;
heuristic function importance factor: 7;
local pheromone evaporation factor: 0.5;
global pheromone evaporation factor: 0.8; and
constant coefficient: 5.

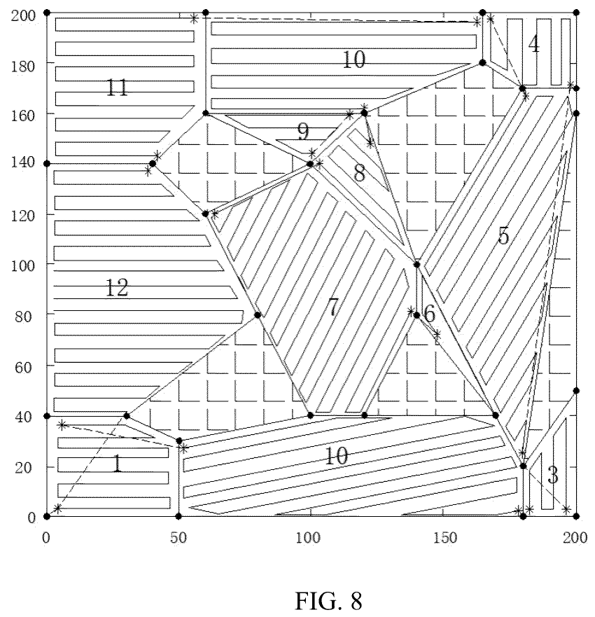

The traversal result of the mobile robot in the example map is shown in FIG. 8.

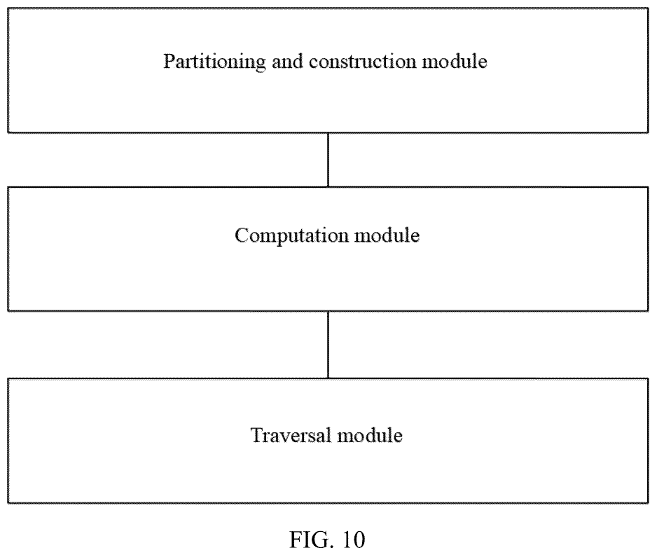

As shown in FIG. 10, the present disclosure provides a system for 2D CCPP of a mobile robot, including:
a partitioning and construction module, configured to partition a map containing obstacles into a plurality of traversable sub-regions to construct a free space for 2D path planning using Maklink lines generated based on Maklink graph theory;
a computation module, configured to determine an optimal sub-region visitation sequence using a 1D ACO algorithm, and to generate an optimal inter-sub-region transition path for the robot within the 2D free space using a 2D ACO algorithm that minimizes a function value; and
a traversal module, configured to perform back-and-forth traversal by sequentially executing a Boustrophedon coverage path within each sub-region in an order guided by the optimal sub-region visitation sequence and the optimal inter-sub-region transition path.

In the computation module, a specific process for generating an optimal inter-sub-region transition path for the robot within the 2D free space using a 2D ACO algorithm that minimizes a function value includes the following steps:
an objective function is defined as a path length from a start point to an end point passing through selected points on specific Maklink lines, with coordinates of these points as independent variables; the involved Maklink lines are normalized; corresponding actual point positions on the Maklink lines are computed through denormalization using normalized results for each computational iteration; an optimal inter-region path is obtained for the mobile robot through multiple such iterations; and a secondary optimization is performed on the obtained optimal inter-region path via triangle pruning, where if multiple consecutive nodes Vᵢ, . . . , Vᵢ, . . . , Vₖ in a path form a polyline and a direct connection between Vᵢ and Vₖ is obstacle-free, polyline segments between Vᵢ and Vₖ are capable of being replaced with a straight line segment between Vᵢ and Vₖ.

An embodiment of the present disclosure provides a terminal device. The terminal device of this embodiment includes: a processor, a memory, and a computer program stored in the memory and executable on the processor. The processor, when executing the computer program, implements the steps in the various method embodiments described above. Alternatively, the processor, when executing the computer program, implements the functions of the modules/units in the various apparatus embodiments described above.

The computer program may be split into one or more modules/units, which are stored in the memory and executed by the processor to accomplish the present disclosure.

The terminal device may be a computing device such as a desktop computer, a notebook, a handheld computer, or a cloud server. The terminal device may include, but is not limited to, a processor and a memory.

The processor may be a central processing unit (CPU), or may be another general-purpose processor, a digital signal processor (DSP), an application specific integrated circuit (ASIC), a field-programmable gate array (FPGA), or other programmable logic device, discrete gate or transistor logic device, discrete hardware component, or the like.

The memory is configured to store the computer program and/or modules. The processor implements the various functions of the terminal device by executing the computer program and/or modules stored in the memory and by accessing data stored therein.

If the integrated modules/units of the terminal device are implemented as software functional units and sold or used as independent products, the modules/units may be stored in a computer-readable storage medium. Based on this concept, all or part of the processes in the method embodiments described above may also be implemented by a computer program instructing relevant hardware. The computer program may be stored in a computer-readable storage medium. When executed by a processor, the computer program can implement the steps of the various method embodiments. The computer program includes computer program code, which may take the form of source code, object code, an executable file, or certain intermediate forms. The computer-readable medium may include, but is not limited to, any entity or device capable of carrying the computer program code, a recording medium, a universal serial bus (USB) flash drive, a removable hard disk, a magnetic disk, an optical disc, a computer memory, a read-only memory (ROM), a random access memory (RAM), an electrical carrier signal, a telecommunications signal, and a software distribution medium. It is to be noted that the content encompassed by the computer-readable medium may be subject to appropriate additions or reductions according to the requirements of legislation and patent practice within a given jurisdiction. For instance, in certain jurisdictions, under local legislation and patent practice, computer-readable media may exclude electrical carrier signals and telecommunications signals.

While the embodiments of the present disclosure have been described above with reference to the accompanying drawings, the present disclosure is not limited to the specific implementations and application fields described. The specific implementations provided are merely illustrative and exemplary, not restrictive. Under the guidance of this specification and without departing from the scope protected by the claims of the present disclosure, those of ordinary skill in the art may devise various other forms and modifications, all of which fall within the scope of protection of the present disclosure.

1. A method for two-dimensional (2D) complete coverage path planning (CCPP) of a mobile robot, comprising the steps of:
partitioning a map containing obstacles into a plurality of traversable sub-regions to construct a free space for 2D path planning using Maklink lines generated based on Maklink graph theory;
determining an optimal sub-region visitation sequence using a one-dimensional (1D) ant colony optimization (ACO) algorithm, and generating an optimal inter-sub-region transition path for the robot within the 2D free space using a 2D ACO algorithm that minimizes a function value; and
sequentially performing back-and-forth traversal by sequentially executing a Boustrophedon coverage path within each sub-region in an order guided by the optimal sub-region visitation sequence and the optimal inter-sub-region transition path, wherein
the generating an optimal inter-sub-region transition path for the robot within the 2D free space using a 2D ACO algorithm that minimizes a function value comprises the steps of:
releasing more pheromone on shorter paths by an ant colony, and gradually increasing pheromone concentrations accumulated on the shorter paths over time; attracting subsequent ants to select the shorter paths; causing the ant colony to converge, through positive feedback, onto a single optimal path, which corresponds to an optimal solution of an optimization problem; and outputting the converged optimal path as an optimal inter-sub-region transition path for the robot by applying the ACO algorithm that minimizes a function value:
$$P = \{ {p}_{1} , {p}_{2} , … , {p}_{k} \}$$
$${P}_{i} = \{ S , {V}_{1} , {V}_{2} , … {V}_{d} , T \}$$
where V₁, V₂, . . . V_{d} denote nodes through which the path passes in sequence, Lᵢ(i=1, 2, . . . , d) denotes a corresponding free link line, and S and T denote a start point and an end point, respectively;
defining
$${V}_{i}^{( 0 )} and {V}_{i}^{( 1 )}$$
as two endpoints of Lᵢ, and representing other points on the link line, within the free space corresponding to one side of an obstacle, as follows:
$${V}_{i} ( {h}_{i} ) = {V}_{i}^{( 0 )} + ( 1 - {h}_{i} ) {V}_{i}^{( 1 )}$$
where hᵢ is a scaling parameter with hᵢ∈[0,1], i=1, 2, . . . , d; a set (h₁, h₂, . . . , h_{d}) corresponds to a path, and (h₁, h₂, . . . , h_{d}) is an optimized solution obtained by the ACO algorithm that minimizes a function value; and
with function value minimization serving as a methodology for determining the shortest path between two points, a principle of the algorithm that minimizes a function value being illustrated below using a three-segment path as a concrete example, and the algorithm comprises the steps of:
setting start point coordinates as (xₛ, yₛ) and end point coordinates as (xₜ, yₜ); defining start and end points of a first segment in the three-segment path as (x₁₀, y₁₀) and (x₁ₑ, y₁ₑ), respectively, with the first segment represented by a vector V̅=(a₁, b₁), where a₁=x₁ₑ−x₁₀ and b₁=y₁ₑ−y₁₀; and obtaining an expression: (x₁, y₁)=(x₁₀, y₁₀)+t₁ (a₁, b₁), t₁∈[0,1];
defining start and end points of a second segment as (x₂₀, y₂₀) and (x₂ₑ−y₂ₑ), respectively, and those of a third segment as (x₃₀, y₃₀) and (x₃ₑ, y₃ₑ); and applying the same principle to obtain:
$${a}_{2} = {x}_{2 e} - {x}_{20} , {b}_{2} = {y}_{2 e} - {y}_{20} , and {a}_{3} = {x}_{3 e} - {x}_{30} , {b}_{3} = {y}_{3 e} - {y}_{30}$$
$$( {x}_{2} , {y}_{2} ) = ( {x}_{20} , {y}_{20} ) + {t}_{2} ( {a}_{2} , {b}_{2} ) , {t}_{2} ∈ [ 0 , 1 ]$$
$$( {x}_{3} , {y}_{3} ) = ( {x}_{30} , {y}_{30} ) + {t}_{3} ( {a}_{3} , {b}_{3} ) , {t}_{3} ∈ [ 0 , 1 ]$$
obtaining an expression for a path length from the start point to the end point, as follows:
$$f ( {t}_{1} , {t}_{2} , {t}_{3} ) = \sqrt{{( {x}_{s} - {x}_{1} )}^{2} + {( {y}_{s} - {y}_{1} )}^{2}} + \sqrt{{( {x}_{1} - {x}_{2} )}^{2} + {( {y}_{1} - {y}_{2} )}^{2}} + \sqrt{{( {x}_{3} - {x}_{t} )}^{2} + {( {y}_{3} - {y}_{t} )}^{2}}$$
applying the ACO algorithm to iteratively solve the expression for the path length to find an optimal value, the optimal value comprising a minimum function value obtained in each iteration and corresponding values of independent variables obtained;
obtaining solutions for t₁, t₂, t₃ and corresponding path length values fᵢ for each iteration, defining a maximum value from the path length values as fₘₐₓ and a minimum value as fₘᵢₙ, and defining a pheromone as follows:
$${f}_{max} - {f}_{i} = {Tau}_{i}$$
obtaining an expression of a heuristic function during iteration using the ACO algorithm, as follows:
$$TMT = \vert Tau - min ( Tau ) \vert$$
obtaining an expression of an ant's state transition probability, as follows:
$${P}_{O} = {Tau}^{alpha} \times {TmT}^{beta}$$
$$PT = {P}_{O} / sum ( {P}_{O} )$$
where a smaller function value corresponds to a greater transition probability such that a local search is favored, and a larger function value corresponds to a smaller transition probability such that a global search is favored;
performing an iterative optimization with the colony of ants by: conducting a local search by the colony of ants if a state transition probability value is greater than P_{O}, wherein a search range for t is confined to
$$\pm \frac{1}{T} ,$$
and T denotes a number of iterations; and conducting a global search if the state transition probability value is less than P_{O}, wherein the search range for t is set to [0,1]; and continuing the search until values for t₁, t₂, t₃ are obtained that minimize the path length f (t₁, t₂, t₃); and
setting a value tᵢ=0 if tᵢ<0 (i=1,2,3) and setting a value tᵢ=1 if tᵢ>1(i=1,2,3) during an iterative solving process, and substituting the set values in a next iterative computation; and repeating iterative computations until either a predefined maximum number of iterations is reached or an optimal value remains unchanged over a predefined number of consecutive generations; and obtaining a minimum function value as determined by the ACO algorithm.

2. The method for 2D CCPP of a mobile robot according to claim 1, wherein the partitioning a map containing obstacles into a plurality of sub-regions and constructing a free space for 2D path planning using Maklink lines generated based on Maklink graph theory comprises the steps of:
modeling obstacles within an experimental environment space as concave-convex polygons; connecting vertices of different obstacles using Maklink lines, wherein each Maklink line does not intersect any obstacle, forms an external angle no greater than 180° with obstacle boundaries, and does not intersect other Maklink lines; and partitioning a workspace into a plurality of convex polygons to construct traversable sub-regions for the mobile robot using the generated Maklink lines, the obstacle boundaries, and boundaries of the 2D map.

3. The method for 2D CCPP of a mobile robot according to claim 1, wherein the determining an optimal sub-region visitation sequence using a 1D ACO algorithm comprises the steps of:
identifying adjacent sub-regions that share a common edge; assigning a connection weight of 1 to each pair of such adjacent sub-regions; treating each sub-region as a node to generate a corresponding adjacency matrix; determining a distance between any two sub-regions based on the adjacency matrix; and obtaining a visitation order for the robot by applying a 1D ACO algorithm to solve a traveling salesman problem (TSP).

4. The method for 2D CCPP of a mobile robot according to claim 1, wherein the sequentially performing back-and-forth traversal by sequentially executing a Boustrophedon coverage path within each sub-region in an order guided by the optimal sub-region visitation sequence and the optimal inter-sub-region transition path comprises the steps of:
moving the mobile robot to a sub-region to be traversed according to the optimal sub-region visitation sequence and the optimal inter-sub-region transition path; and performing a back-and-forth reciprocating motion along a longest edge of the sub-region to be traversed until reaching an opposite vertex of the edge, at which point the mobile robot continues the reciprocating motion along the same longest edge to achieve CCPP.

5. A system for 2D CCPP of a mobile robot, for implementing the method for 2D CCPP of a mobile robot according to claim 1, comprising:
a partitioning and construction module, configured to partition a map containing obstacles into a plurality of traversable sub-regions to construct a free space for 2D path planning using Maklink lines generated based on Maklink graph theory;
a computation module, configured to determine an optimal sub-region visitation sequence using a 1D ACO algorithm, and to generate an optimal inter-sub-region transition path for the robot within the 2D free space using a 2D ACO algorithm that minimizes a function value; and
a traversal module, configured to perform back-and-forth traversal by sequentially executing a Boustrophedon coverage path within each sub-region in an order guided by the optimal sub-region visitation sequence and the optimal inter-sub-region transition path.

6. A system for 2D CCPP of a mobile robot, for implementing the method for 2D CCPP of a mobile robot according to claim 2, comprising:
a partitioning and construction module, configured to partition a map containing obstacles into a plurality of traversable sub-regions to construct a free space for 2D path planning using Maklink lines generated based on Maklink graph theory;
a computation module, configured to determine an optimal sub-region visitation sequence using a 1D ACO algorithm, and to generate an optimal inter-sub-region transition path for the robot within the 2D free space using a 2D ACO algorithm that minimizes a function value; and
a traversal module, configured to perform back-and-forth traversal by sequentially executing a Boustrophedon coverage path within each sub-region in an order guided by the optimal sub-region visitation sequence and the optimal inter-sub-region transition path.

7. A system for 2D CCPP of a mobile robot, for implementing the method for 2D CCPP of a mobile robot according to claim 3, comprising:
a partitioning and construction module, configured to partition a map containing obstacles into a plurality of traversable sub-regions to construct a free space for 2D path planning using Maklink lines generated based on Maklink graph theory;
a computation module, configured to determine an optimal sub-region visitation sequence using a 1D ACO algorithm, and to generate an optimal inter-sub-region transition path for the robot within the 2D free space using a 2D ACO algorithm that minimizes a function value; and
a traversal module, configured to perform back-and-forth traversal by sequentially executing a Boustrophedon coverage path within each sub-region in an order guided by the optimal sub-region visitation sequence and the optimal inter-sub-region transition path.

8. A system for 2D CCPP of a mobile robot, for implementing the method for 2D CCPP of a mobile robot according to claim 4, comprising:
a partitioning and construction module, configured to partition a map containing obstacles into a plurality of traversable sub-regions to construct a free space for 2D path planning using Maklink lines generated based on Maklink graph theory;
a computation module, configured to determine an optimal sub-region visitation sequence using a 1D ACO algorithm, and to generate an optimal inter-sub-region transition path for the robot within the 2D free space using a 2D ACO algorithm that minimizes a function value; and
a traversal module, configured to perform back-and-forth traversal by sequentially executing a Boustrophedon coverage path within each sub-region in an order guided by the optimal sub-region visitation sequence and the optimal inter-sub-region transition path.

9. The system for 2D CCPP of a mobile robot according to claim 5, wherein in the computation module, a specific process for generating an optimal inter-sub-region transition path for the robot within the 2D free space using a 2D ACO algorithm that minimizes a function value comprises the steps of:
defining an objective function as a path length from a start point to an end point passing through selected points on specific Maklink lines, with coordinates of these points as independent variables; normalizing the involved Maklink lines; computing corresponding actual point positions on the Maklink lines through denormalization using normalized results for each computational iteration; obtaining an optimal inter-region path for the mobile robot through multiple such iterations; and
performing a secondary optimization on the obtained optimal inter-region path via triangle pruning, wherein if multiple consecutive nodes Vᵢ, . . . , Vⱼ, . . . , Vₖ in a path form a polyline and a direct connection between Vᵢ and Vₖ is obstacle-free, polyline segments between Vᵢ and Vₖ are capable of being replaced with a straight line segment between Vᵢ and Vₖ.

10. The system for 2D CCPP of a mobile robot according to claim 6, wherein in the computation module, a specific process for generating an optimal inter-sub-region transition path for the robot within the 2D free space using a 2D ACO algorithm that minimizes a function value comprises the steps of:
defining an objective function as a path length from a start point to an end point passing through selected points on specific Maklink lines, with coordinates of these points as independent variables; normalizing the involved Maklink lines; computing corresponding actual point positions on the Maklink lines through denormalization using normalized results for each computational iteration; obtaining an optimal inter-region path for the mobile robot through multiple such iterations; and
performing a secondary optimization on the obtained optimal inter-region path via triangle pruning, wherein if multiple consecutive nodes Vᵢ, . . . , Vⱼ, . . . , Vₖ in a path form a polyline and a direct connection between Vᵢ and Vₖ is obstacle-free, polyline segments between Vᵢ and Vₖ are capable of being replaced with a straight line segment between Vᵢ and Vₖ.

11. The system for 2D CCPP of a mobile robot according to claim 7, wherein in the computation module, a specific process for generating an optimal inter-sub-region transition path for the robot within the 2D free space using a 2D ACO algorithm that minimizes a function value comprises the steps of:
defining an objective function as a path length from a start point to an end point passing through selected points on specific Maklink lines, with coordinates of these points as independent variables; normalizing the involved Maklink lines; computing corresponding actual point positions on the Maklink lines through denormalization using normalized results for each computational iteration; obtaining an optimal inter-region path for the mobile robot through multiple such iterations; and performing a secondary optimization on the obtained optimal inter-region path via triangle pruning, wherein if multiple consecutive nodes Vᵢ, . . . , Vⱼ, . . . , Vₖ in a path form a polyline and a direct connection between Vᵢ and Vₖ is obstacle-free, polyline segments between Vᵢ and Vₖ are capable of being replaced with a straight line segment between Vᵢ and Vₖ.

12. The system for 2D CCPP of a mobile robot according to claim 8, wherein in the computation module, a specific process for generating an optimal inter-sub-region transition path for the robot within the 2D free space using a 2D ACO algorithm that minimizes a function value comprises the steps of:
defining an objective function as a path length from a start point to an end point passing through selected points on specific Maklink lines, with coordinates of these points as independent variables; normalizing the involved Maklink lines; computing corresponding actual point positions on the Maklink lines through denormalization using normalized results for each computational iteration; obtaining an optimal inter-region path for the mobile robot through multiple such iterations; and performing a secondary optimization on the obtained optimal inter-region path via triangle pruning, wherein if multiple consecutive nodes Vᵢ, . . . , Vⱼ, . . . , Vₖ in a path form a polyline and a direct connection between Vᵢ and Vₖ is obstacle-free, polyline segments between Vᵢ and Vₖ are capable of being replaced with a straight line segment between Vᵢ and Vₖ.

13. A computer device, comprising a memory, a processor, and a computer program stored in the memory and running on the processor, which, when executing the computer program, implements the steps of the method for 2D CCPP of a mobile robot according to claim 1.

14. A computer device, comprising a memory, a processor, and a computer program stored in the memory and running on the processor, which, when executing the computer program, implements the steps of the method for 2D CCPP of a mobile robot according to claim 2.

15. A computer device, comprising a memory, a processor, and a computer program stored in the memory and running on the processor, which, when executing the computer program, implements the steps of the method for 2D CCPP of a mobile robot according to claim 3.

16. A computer device, comprising a memory, a processor, and a computer program stored in the memory and running on the processor, which, when executing the computer program, implements the steps of the method for 2D CCPP of a mobile robot according to claim 4.

17. A computer-readable storage medium, comprising a computer program stored thereon, which, when executed by a processor, implements the steps of the method for 2D CCPP of a mobile robot according to claim 1.

18. A computer-readable storage medium, comprising a computer program stored thereon, which, when executed by a processor, implements the steps of the method for 2D CCPP of a mobile robot according to claim 2.

19. A computer-readable storage medium, comprising a computer program stored thereon, which, when executed by a processor, implements the steps of the method for 2D CCPP of a mobile robot according to claim 3.

20. A computer-readable storage medium, comprising a computer program stored thereon, which, when executed by a processor, implements the steps of the method for 2D CCPP of a mobile robot according to claim 4.
